(19) United States
(12) Patent Application Publication
(10) Pub. No.: US 2026/0023551 A1
(43) Pub. Date: Jan. 22, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: KOICHI TANABE, Kanagawa (JP)

(21) Appl. No.: 19/241,777

(22) Filed: Jun. 18, 2025

(30) Foreign Application Priority Data
Jul. 19, 2024 (JP) 2024-115713

(51) Int. Cl. G06F 8/65

(52) U.S. Cl. CPC G06F 8/65

(57) ABSTRACT

An image management apparatus is operated by an application includes: an obtainment unit configured to obtain information indicating a scope of the authorization granted before a version update of the application to the application to use a linked resource server and a notification unit configured to give a predetermined notification to a user in a case where the scope does not include authorization necessary for the user to use a function added as a result of the version update of the application.

### BACKGROUND

### Field of the Technology

The present disclosure relates to a method for managing an image.

### Description of the Related Art

There is a resource server that provides an external service for managing image files and the like using, e.g., cloud computing. Meanwhile, there is a client apparatus in which an application program (hereinafter simply referred to as “application”) authorized to use such a resource server runs. Linkage between such a client apparatus and such a resource server allows implementation where an image file processed in the client apparatus is managed by the resource server. In this case, the application running in the client apparatus is granted authorization to use the resource server within a scope assigned thereto. A technique called OAuth 2.0 is widely used as an authentication method used to grant authorization to an application.

Japanese Patent Laid-Open No. 2017-59219 proposes a method for determining the scope of resources of an external storage service available to an application which performs processing in cooperation with the external storage service.

### SUMMARY

An image management apparatus of the present disclosure is an image management apparatus operated by an application, the image management apparatus including: an obtainment unit configured to obtain information indicating a scope of the authorization granted before a version update of the application to the application to use a linked resource server and a notification unit configured to give a predetermined notification to a user in a case where the scope does not include authorization necessary for the user to use a function added as a result of the version update of the application. Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example configuration of an image management system;

FIG. 2 is a diagram showing an example hardware configuration of an image management apparatus;

FIGS. 3A and 3B are diagrams illustrating a transfer function provided by an application;

FIGS. 4A and 4B are diagrams each showing an example of a screen displayed at the time of linking an application to a resource server;

FIG. 5 is a diagram showing an example of a functional configuration of an application in an image management apparatus;

FIGS. 6A to 6C are diagrams each showing an example of a linkage setting screen;

FIG. 7 is a diagram showing an example of a data structure managing approval information;

FIG. 8 is a diagram showing an example of a data structure for managing policies of resource servers;

FIG. 9 is a diagram showing an example of a data structure for managing messages to present to a user;

FIG. 10 is a flowchart showing an example of processing to display a message;

FIGS. 11A to 11C are diagrams showing an example of a message screen; and

FIG. 12 is a flowchart illustrating processing performed after a message is displayed.

### DESCRIPTION OF THE EMBODIMENTS

Embodiments of a technique of the present disclosure are described with reference to the drawings. Constituents described in the following embodiments are merely exemplary, and there is no intention of limiting the scope of the technique of the present disclosure only to the following embodiments. The technique of the present disclosure is not limited to the following embodiments and encompasses various other modes without departing from the gist of the technique of the present disclosure. Some of the following embodiments may be combined as needed.

The version of the application running in the client apparatus is repeatedly updated in order to correct errors or improve functionality. Thus, even if an application in an old version has been authorized to use a resource server, the granted authorization may be insufficient for the application in a new version, requiring additional authorization granting.

However, it is not easy for a user to know whether additional authorization need to be granted to the application updated to a new version. Also, a user may not know how to grant additional authorization to the application. Japanese Patent Laid-Open No. 2017-59219 makes no mention of how to grant additional authorization to an application. Thus, there is a concern that after a version update of the application, a user may fail to properly perform an operation needed to enable the added function.

### Embodiment 1

### [System Configuration]

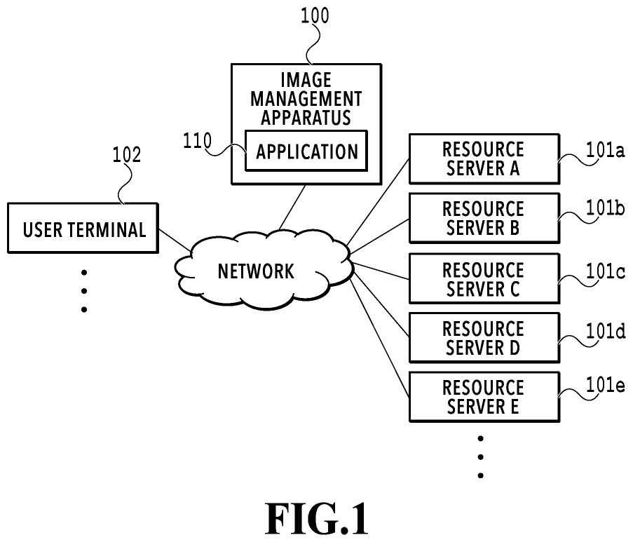

FIG. 1 is a diagram showing an example configuration of an image management system according to the present embodiment. The image management system includes an image management apparatus 100, a user terminal 102, and resource servers 101a to 101e.

The image management apparatus 100 is an information processing apparatus configured to provide a service which, e.g., receives image data transmitted from a camera or terminal of a user having an account to be described later and saves the image data received. The service provided by the image management apparatus 100 is, for example, a cloud service for saving an image captured by a digital camera and uploaded in real time using a network such as Wi-Fi. The user is provided with various functions by an application 110 that runs in the image management apparatus 100. The functions provided by the application 110 will be described later. The image management apparatus 100 is connected to one or more resource servers 101 and one or more user terminals 102 through a network.

A user as referred to herein is a user who has an account for a service provided by the application 110 that runs in the image management apparatus 100 and who uses the service provided by the application 110. A user can generate an account through the user terminal 102 owned by the user and connected to a network. The user terminal 102 is a personal computer (PC), a tablet, a smartphone, a camera, or the like. The user terminal 102 may be the same terminal as the terminal which uploads an image to the image management apparatus 100.

The application 110 that runs in the image management apparatus 100 can display a screen on the user terminal 102. Through the screen, the user can give various instructions to the application 110 running in the image management apparatus 100. For example, the user can view or delete the user's image managed by the image management apparatus 100. Through the screen, the user can also change a setting related to the service provided by the application running in the image management apparatus 100.

The resource servers 101a to 101e are each an information processing apparatus that provides a service such as a storage service, an edit service, or a microblogging service. A service provided by the resource servers 101a to 101e may be called an external service in order to be distinguished from a service provided by the application 110 running in the image management apparatus 100. Although the following description assumes that the image management system includes various resource servers 101a to 101e each of which provides an external service, there is no limitation as to the number of resource servers 101a to 101e. A resource server as stated herein also refers to an external service run by the resource server. Also, each of the resource servers 101a to 101e may be written simply as a resource server 101.

Examples of the network include a local area network (LAN) and the Internet. The image management apparatus 100, the resource servers 101a to 101e, and the user terminal 102 are connected through the network and are therefore configured to be able to communicate with one another.

### [Hardware Configuration]

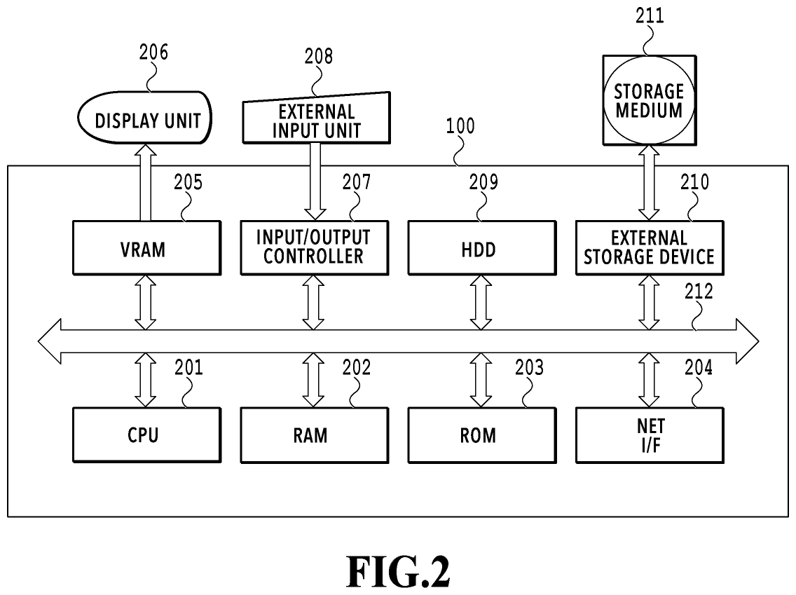

FIG. 2 is a diagram showing an example hardware configuration of the image management apparatus 100, which is the information processing apparatus of the present embodiment.

A CPU 201 performs control of computations performed in each process and control of each unit. Note that the image management apparatus 100 may be configured having, apart from the CPU 201, one or more pieces of dedicated hardware to execute at least part of the processing performed by the CPU 201. Examples of the dedicated hardware include a processor used for performing image processing or control, an application-specific integrated circuit (ASIC), a field-programmable gate array (FPGA), and a digital signal processor (DSP).

A RAM 202 is memory which functions as main memory for the CPU 201 and is used as a region to load an execution program into and a region for data.

A ROM 203 is memory storing an operation processing procedure for the CPU 201. For example, the ROM 203 includes a region for recording basic software (operating system (OS)), which is a system program for performing device control of the image management apparatus 100, and a region for recording, e.g., information necessary for the system to operate. Also, data stored in the ROM 203 may be stored in an HDD 209 to be described later. Also, the image management apparatus 100 may include, in place of or in addition to the HDD 209, a storage unit such as NAND flash memory, a Secure Digital (SD) card, or a solid-state drive (SSD). In this case, the aforementioned data stored in the ROM 203 may be stored in these storage units.

A NET I/F 204 is a network interface and is used to communicate with the resource server 101 or the user terminal 102 through the network.

A VRAM 205 performs display control to display a screen showing the operation status of the image management apparatus 100 on a display unit 206 as instructed by the CPU 201. The display unit 206 is, for example, a display device such as a display.

An input/output controller 207 controls input signals from an external input unit 208. The external input unit 208 is a device that receives an operation performed by an operator. The external input unit 208 is an input device such as a keyboard, a pointing device such as a mouse, or a touch panel display.

The HDD 209 is a storage unit used as a storage region for storing applications and various kinds of data.

An external storage device 210 is a device for reading a storage medium 211. For example, the external storage device 210 is a removable disk drive such as a floppy disk drive, a CD-ROM drive, or an SD card reader. The storage medium 211 is a storage medium readable by the external storage device 210. For example, the storage medium 211 is a removable data storage device (a removable medium) such as a magnetic recording medium like a floppy disk, an optical recording medium (e.g., a CD-ROM), a magnetooptical recording medium (e.g., a magnetooptical (MO) disk), or a semiconductor recording medium (e.g., an SD card).

The external storage device 210 is used to, e.g., read an application or data stored in the HDD 209 described earlier from the storage medium 211. Alternatively, an application and data may be received from an apparatus connected to the network through the NET I/F 204.

A transmission bus 212 is a path for performing data exchange between devices. Data transmission between the CPU 201, the RAM 202, the ROM 203, the NET I/F 204, the VRAM 205, the input/output controller 207, the HDD 209, and the external storage device 210 is performed through the transmission bus 212.

Although there is one image management apparatus 100 in the present embodiment for illustrative convenience, the image management apparatus 100 may be a system having a plurality of information processing apparatuses behaving as a single image management apparatus 100.

[Functions that the Application 110 Provides to a User]

The application 110 that runs in the image management apparatus 100 may have a version update, and as a result of the version update, a function available to the user may be added. The present embodiment assumes that versions of the application 110 include an old version and a new version to which the old version is updated.

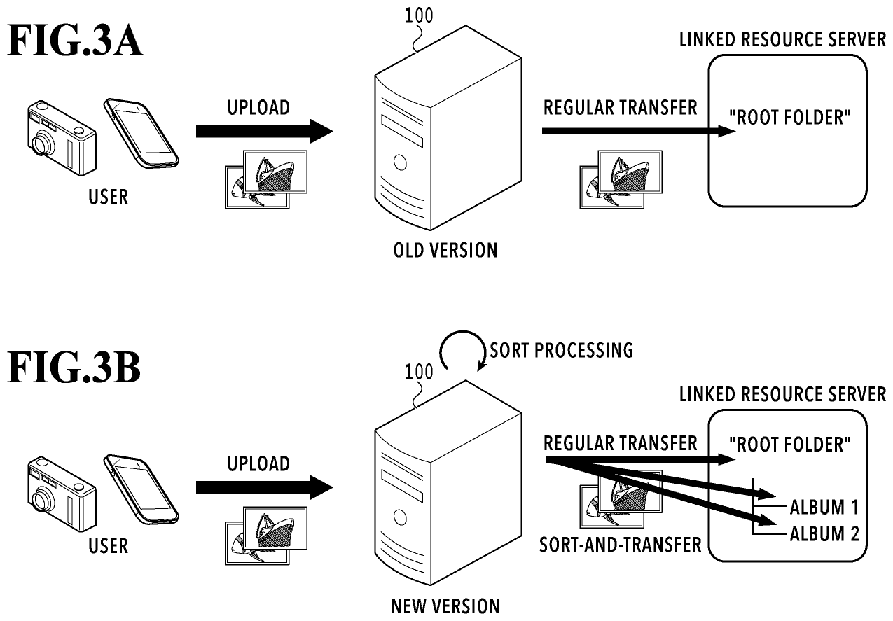

FIGS. 3A and 3B are diagrams illustrating functions provided by the application 110. FIG. 3A is a diagram illustrating a function provided by the application in the old version, and FIG. 3B is a diagram illustrating a function provided by the application 110 in the new version.

The application 110 in the old version has a regular transfer function to save a user's image to a predetermined location in a linked resource server, the image having been uploaded from the user to the image management apparatus 100 and managed by the application 110 of the image management apparatus 100. As shown in FIG. 3A, the predetermined location is, for example, a root folder.

A linked resource server is, among resource servers for which a user has accounts, a resource server that the user has permitted the application 110 to access. Although the following description using FIGS. 3A and 3B assumes that the linked resource server is the resource server 101a of the resource servers 101a to 101e, any of the resource servers 101a to 101e can be a linked resource server. Also, the linked resource server is different for every user. There may be more than one linked resource server.

The application 110 in the new version has, in addition to the function provided by the application 110 in the old version, a sort function and a sort-and-transfer function (also called a sorted image transfer function).

The sort function is a function where the application 110 selects, from a particular user's images managed by the application 110, an image meeting a registered sorting condition. For example, in a case where a sorting condition for sorting an image including a cat is registered, an image including a cat is selected from the particular user's images managed by the application 110. Processing for selecting an image meeting a sorting condition is also referred to as “sorting” or “sort processing.” A plurality of sorting conditions may be registered, in which case the sort processing is performed for each of the registered sorting conditions. The sorted image is managed in association with an identifier indicating the sorting condition met by the sorted image.

The sort-and-transfer function is a function where the application 110 creates, in the linked resource server 101a, an album for each of the registered sorting condition. In a case where the linked resource server 101a has an album function, the user can enable the sort-and-transfer function of the application 110. In a case where there are a plurality of linked resource servers, the sort-and-transfer function can be enabled for each one of the linked resource servers.

An album refers to a holder where image files are collectively managed. In other words, a folder storing image files meeting a certain sorting condition is also an album. The following description assumes that the resource server 101a has the album function. A user can display images belonging to an album in the form of, e.g., a list.

As an example, it is assumed here that the following conditions are registered in the application 110: a sorting condition 1 for sorting an image including a ship and a sorting condition 2 for sorting an image including a fish. In this case, the sorting function of the application 110 sorts, from a particular user's images managed by the application 110, an image including a ship and an image including a fish.

Then, in a case where the sorted image transfer function is enabled, the application 110 executes sort-and-transfer. In sort-and-transfer, the application 110 transfers sorted images to the linked resource server 101a so that albums of images meeting respective sorting conditions may be generated in the linked resource server 101a. For example, the application 110 generates two empty albums in the linked resource server 101a and transfers an image meeting the sorting condition 1 to one of the albums and an image meeting the sorting condition 2 to the other one of the albums. In a case where albums have already been generated in the linked resource server 101a, the application 110 transfers an image meeting a sorting condition to an album corresponding to the sorting condition.

In this way, an album 1 storing images including a fish and an album 2 storing images including a ship are generated (updated) in the linked resource server 101a. Thus, to enable the sort-and-transfer function, not only does the linked resource server 101a need to have the album function, but also the application 110 needs to be granted authorization to generate an album in the linked resource server 101a.

### [Delegating Authorization]

Granting the application 110 with authorization that a user has for the linked resource server 101a to use resources of the linked resource server 101a is also referred to as delegating authorization to the application 110. In other words, delegating authorization to the application 110 means permitting the application 110 to use resources of the resource server 101a within the determined scope.

A user's authorization to use the resource server 101a (the scope of resources available) includes, for example, saving data to the linked resource server 101a, generating a new album (folder) in the linked resource server 101a, and/or the like. Authorization is delegated in a case where the application 110 is permitted to be linked with the resource server.

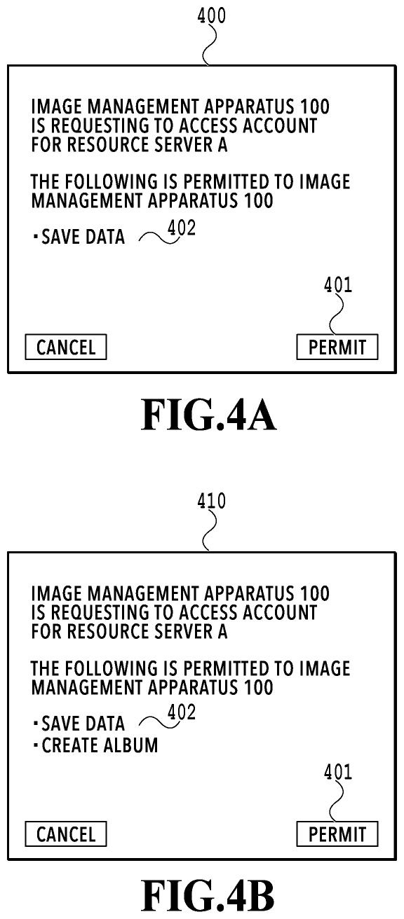

FIGS. 4A and 4B are diagrams each showing an example of a confirmation screen displayed on the user terminal 102 to confirm with a user whether they permit the application 110 to link with an unlinked resource server. For example, in linking the resource server 101a with the application 110, a confirmation screen 400, 410 also displays, in a region 402, the scope of authorization to be delegated (granted) to the application 110. Once a user presses a Permit button 401 on the confirmation screen 400, 410, the resource server 101a becomes a linked resource server. Further, the authorization displayed in the region 402 on the confirmation screen 400 is delegated to the application 110 on the user's account.

It is preferable that only a necessary part of authorization be delegated to the application 110 from the scope of authorization that the user has on their account for the linked resource server 101a. In other words, authorization necessary to execute the functions of the application 110 in the current version is delegated to the application 110.

For example, in a case where a new function is added to the application as a result of a version update, a system administrator of the image management apparatus 100 refers to, e.g., a manual for developers issued by the resource server and checks the authorization to be granted to the application 110. Then, types of authorization necessary for each resource server are managed using a table or the like.

For example, in a case of linking the application 110 in the old version to an unlinked resource server 101a, authorization within a scope necessary for the application 110 to perform regular transfer is delegated. Specifically, as shown in the region 402 in FIG. 4A, the authorization delegated from the user to the application 110 in the old version is authorization to save image data to the resource server 101a and does not include authorization to generate an album.

In the present embodiment, the application 110 in the new version additionally has the sort-and-transfer function. Thus, in order for the user to use the sort-and-transfer function of the application 110, the application 110 needs to be granted not only the authorization to save an image to the resource server 101a, but also the authorization to create an album.

FIG. 4B is a confirmation screen displayed in the event where the user links the application 110 in the new version with the resource server 101a. As the region 402 in FIG. 4B shows, in a case of linking the application 110 in the new version, authorization delegated to the application 110 includes authorization to generate an album. Thus, in a case where the application is linked with the resource server 101a for the first time with the application in the new version, proper authorization is delegated to the application 110.

However, in a case where the application 110 has already been linked with the resource server with the application 110 in the old version, additional authorization is delegated to the application 110 differently depending on the resource server. In the method described in the present embodiment, in order to properly delegate additional authorization to the application 110, a notification is given to a user to help prevent a situation where the user does not perform a required operation.

### [Functional Configuration]

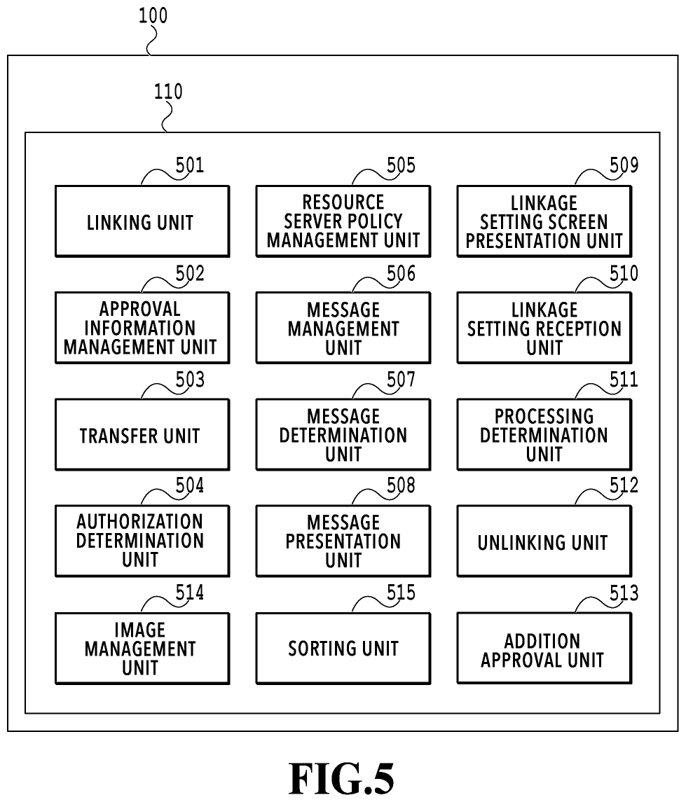

FIG. 5 is a diagram showing an example configuration of functions of the application 110 executed in the image management apparatus 100. In the present embodiment, as shown in FIG. 5, the application 110 in the image management apparatus 100 has processing modules 501 to 515.

Content of an instruction inputted after automatic activation or by an operator through the external input unit 208 is transmitted to the CPU 201. The CPU 201 obtains a program corresponding to one of the processing modules 501 to 515 which is relevant to the content of the received instruction from the ROM 203, the HDD 209, the external storage device 210, the RAM 202, or the like, loads the program into the RAM 202, and executes processing. The CPU 201 writes computation results to the RAM 202, the HDD 209, the external storage device 210, or the like. Also, the CPU 201 functions also as a display control unit configured to display the computation results on the display unit 206 via the VRAM 205 as needed. By the operation described above, processing in accordance with the processing modules 501 to 515 is performed. In this way, the processing modules 501 to 515 operate as part of the application or program used by the CPU 201. Note that some or all of the functions of the processing modules 501 to 515 may be implemented by hardware such as an ASIC or an electronic circuit.

A linking unit 501 performs linkage processing to link with the resource server 101 for which the user has an account. To link the application 110 with a certain resource server 101 on the user's account, the user performs authentication of the application 110 from their own account for the resource server 101 with which to link the application 110. Specifically, the user permits linkage of the application 110 through the aforementioned confirmation screen 400, 410 in FIGS. 4A and 4B. In a case where authorization to use the resources of the linked resource server 101 is delegated to the application 110 at the time of linkage, the resource server 101 issues approval information indicating, e.g., the scope of the delegated authorization. The approval information is managed by an approval information management unit 502 of the application 110 to be described below.

The approval information management unit 502 manages approval information in association with a user ID and a resource server which issued the approval information. The data structure used to manage approval information will be described later.

In a case where an operation instructed by the user is to start processing performed in cooperation with the resource server 101, an authorization determination unit 504 determines, based on approval information managed by the approval information management unit 502, whether authorization necessary for the processing has been delegated from the user.

A resource server policy management unit 505 manages policies for resource servers. A policy indicates, e.g., the scope of authorization for the resource server 101 which can be delegated to the application 110, an operation to be performed in adding authorization, and whether an application programming interface (API) for adding authorization is provided. Because different policies are defined for different resource servers 101, the resource server policy management unit 505 manages policies for the respective resource servers 101. How policies are managed will be described later. The processing modules of the application can refer to the policies and execute processing in accordance with the policies.

A message management unit 506 manages messages to present to a user. How the messages are managed will be described later.

As a result of the determination by the authorization determination unit 504, a message determination unit 507 determines a message based on the policy for the target resource server 101 managed by the resource server policy management unit 505, from the messages managed by the message management unit 506.

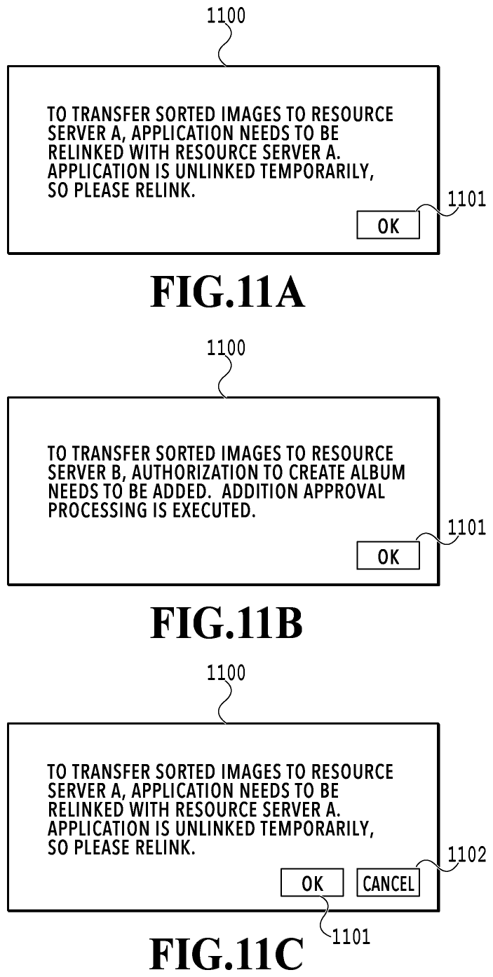

A message presentation unit 508 performs control to generate a message screen 1100 (see FIGS. 11A to 11C) based on the message determined by the message determination unit 507 and display the message screen 1100 on the user terminal 102. Details of the message screen 1100 will be described later.

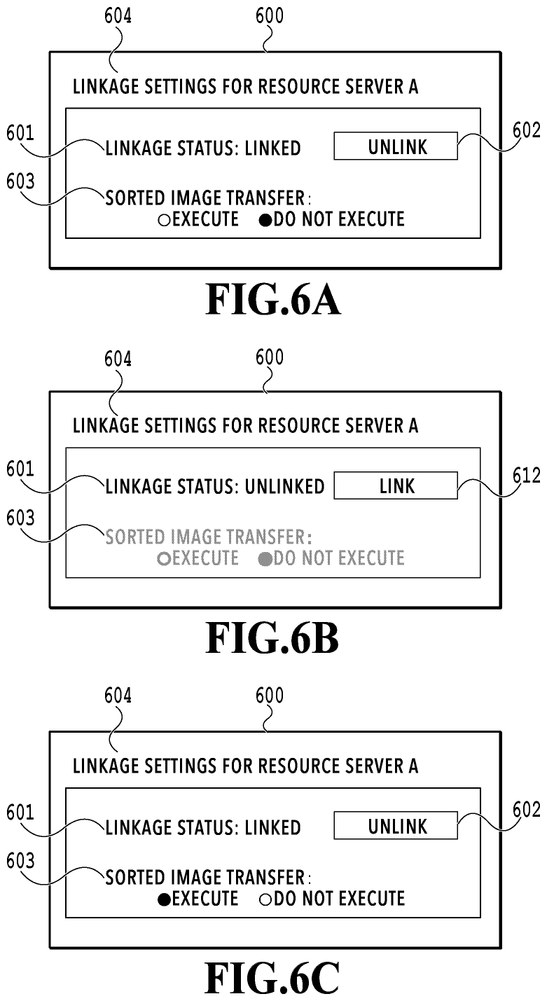

A linkage setting screen presentation unit 509 performs control to generate a linkage setting screen 600 (see FIGS. 6A to 6C) used by the user to configure settings on linkage with the resource server 101 and display the linkage setting screen 600 on the user terminal 102. Details of the linkage setting screen 600 will be described later.

A linkage setting reception unit 510 receives content of instruction given by the user through the linkage setting screen 600. Details will be described later.

After the message presentation unit 508 presents a message, a processing determination unit 511 determines processing necessary for adding authorization, based on the policy for the resource server 101 managed by the resource server policy management unit 505.

An unlink unit 512 unlinks the application 110 from the linked resource server 101. The unlink unit 512 unlinks the application 110 from the linked resource server 101 by deleting approval information on the linked resource server managed by the approval information management unit 502.

In a case where the processing determination unit 511 determines to add authorization, an addition approval unit 513 requests the resource server 101 for additional authorization delegation by executing an addition approval API for the resource server 101. As a result, approval information managed by the approval information management unit 502 is updated.

An image management unit 514 manages an image uploaded from, e.g., an image capture device of a particular user in association with the user ID of the particular user. For example, the image from the user is stored in the HDD 209 or the external storage device 210 and managed.

A sorting unit 515 performs sort processing to select an image meeting a registered sorting condition from a particular user's images managed by the image management unit 514. The sorting unit 515 is included in the application 110 in the new version.

A transfer unit 503 transfers a particular user's images managed by the image management unit 514 to the linked resource server 101 using the approval information managed by the approval information management unit 502. The transfer unit 503 in the new version performs the aforementioned sort-and-transfer in a case where the sort- and-transfer function is enabled.

### [Linkage Setting Screens Presented to a User]

FIGS. 6A to 6C are diagrams each showing an example of the linkage setting screen 600 used by a user to configure settings related to linkage with the resource server 101. The linkage setting screen presentation unit 509 transmits information used to display the linkage setting screen 600 in FIG. 6A, 6B, or 6C to the user terminal 102, and the linkage setting screen 600 is displayed on the display unit of the user terminal 102.

The linkage setting screens 600 in FIGS. 6A to 6C are all a linkage setting screen presented by the linkage setting screen presentation unit 509 of the application 110 in the new version. FIG. 6A is used to describe the linkage setting screen 600. A resource server name display region 604 is a region that displays the name (resource server name) of a resource server on which to configure settings through the linkage setting screen 600 (referred to as a target resource server). In the following description using FIGS. 6A to 6C, the target resource server is the resource server 101a. The resource server name is, for example, the name of an external service provided by the target resource server.

A linkage status display region 601 is a region that displays the status of linkage between the application 110 and the target resource server 101a on the user's account. Either “Linked” or “Unlinked” is displayed as the linkage status.

A button 602, 612 is a button used by a user to instruct the application 110 whether to link with or unlink from the target resource server 101a on the user's account. The label displayed on the button 602, 612 is switched between “Link” and “Unlink” depending on the linkage status displayed in the linkage status display region 601. Also, an operation performed by the application 110 after the button 602, 612 is pressed is switched depending on the label displayed on the button 602, 612. In a case where a Link button 612 labeled as “Link” is pressed by a user, the linking unit 501 links the application 110 with the target resource server 101a on the user's account. In a case where a Unlink button 602 labeled as “Unlink” is pressed by a user, the unlink unit 512 unlinks the application 110 from the target resource server 101a on the user's account.

A sort-and-transfer selection region 603 is a region to select whether to enable sort-and-transfer with the target resource server 101a on the user's account. Radio buttons corresponding to “Execute” and “Do not execute” are disposed, and a user selects “Execute” or “Do not execute” by pressing either one of the radio buttons. The radio buttons are selectable in a case where “Linked” is displayed in the linkage status display region 601. After linkage with the target resource server 101a, the linkage setting screen 600 displayed by default will have the radio button for “Do not execute” selected in the sort-and-transfer selection region 603. The sort-and-transfer selection region 603 is a setting item added anew as a result of addition of the sort-and-transfer function due to an update of the application 110 to the new version.

FIG. 6B is a diagram showing an example of the linkage setting screen 600 displayed in a case where the application 110 is yet to be linked with the target resource server 101a on the user's account. Thus, “Unlinked” indicating no linkage is displayed in the linkage status display region 601, and the Link button 612 is labeled as “Link.” Also, in a case where “Unlinked” is displayed in the linkage status display region 601, the radio buttons are displayed in a grayed-out manner so as not to be pressed, i.e., to indicate that they are not selectable.

### [Approval Information]

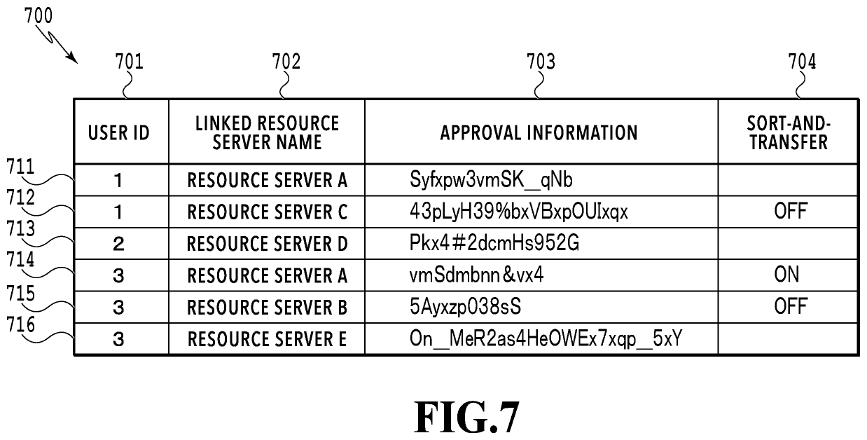

FIG. 7 is a diagram showing an approval information management table 700 which is an example data structure of information managed by the approval information management unit 502. Although the approval information management unit 502 manages approval information and information related to the approval information in a table format in the following description as an example, the format of data structure for managing approval information is not limited to a table format.

A column 701 of the approval information management table 700 holds the value of a user ID uniquely identifying a user.

A column 702 holds an aforementioned resource server name as information for identifying a linked resource server with which the user identified by the user ID held in the column 701 of the same row has permitted the application 110 to link. It is assumed here that the column 702 holds the same resource server names as those managed by the policy-managing data structure to be described later.

A column 703 holds approval information issued by a resource server 101 whose name is held in the column 702 of the same row after the user whose user ID is held in the column 701 of the same row delegates authorization for the resource server 101 to the application 110. The application 110 can obtain content of the authorization included in the approval information by transmitting the approval information to the resource server 101 for inquiry. Using the authorization included in the approval information, the application 110 transfers an image to the resource server 101 and creates an album.

The column 703 of a row 711 in FIG. 7 holds approval information issued by linked “Resource Server A.” Also, the column 703 of a row 712 in FIG. 7 holds approval information issued by linked “Resource Server C.” Thus, FIG. 7 shows that the user with a user ID “1” in the column 701 has permitted the application 110 to link with “Resource Server A” and with “Resource Server C” and delegated the user's authorization to the application 110.

A column 704 holds a setting value (a sort-and-transfer setting value) indicative of whether to perform sort-and-transfer with the resource server 101 whose name is held in the column 702 of the same row. The sort-and-transfer setting value is any one of ON, OFF, or a null value. An empty cell in the column 704 indicates that a null value is set therein.

Sort-and-transfer is a function added to the application 110 in the new version. The following case is considered: the application 110 in the old version links with Resource Server A, the application 110 is updated to the new version, and no setting for sort-and-transfer has been configured for Resource Server A on the linkage setting screen 600 yet. In this case, a null value is held in the column 704 of the row 711 holding information on Resource Server A.

“ON” as the sort-and-transfer setting value indicates that execution of sort-and- transfer is enabled. “OFF” as the sort-and-transfer setting value indicates that execution of sort-and-transfer is not enabled although authorization to generate an album has been delegated.

In this way, the approval information management table 700 manages a name indicating a linked resource server 101 with which a user has permitted the application 110 to link and a user ID indicating the user who has permitted the linkage, with the server name and user ID associated with each other. Further, approval information issued by the linked resource server 101 is managed in association with the resource server which issued the approval information.

Once the application 110 is updated to a new version, the approval information management table 700 in FIG. 7 may be changed depending on a function newly added. For example, the approval information management table 700 for the application in the old version has no column 704, whereas the approval information management table 700 for the application in the new version additionally has the column 704.

A relation between the linkage setting screens 600 in FIGS. 6A to 6C and the approval information management table 700 in FIG. 7 is described. An example case is considered here where User 1 whose user ID is “1” instructs the application 110 to display a linkage setting screen used to configure settings on Resource Server A.

In an example scenario where the user 1 has permitted the application 110 in the old version to link with Resource Server A, approval information is held in the column 703 of the row 711 in FIG. 7. Then, as shown in FIG. 6A, “Linked” is displayed in the linkage status display region 601 of the linkage setting screen 600, and an Unlink button 602 labeled as “Unlink” is displayed.

Then, in a case where User 1 has not configured a sort-and-transfer setting for Resource Server A yet on the linkage setting screen 600 after an update of the application 110 to the new version, a null value is held as the sort-and-transfer setting value as shown in the column 704 of the row 711 in FIG. 7. In a case where the sort-and-transfer setting value is a null value, as shown in FIG. 6A, the sort-and-transfer selection region 603 is displayed with the radio button for “Do not execute” being selected. Thus, in a case where the sort-and-transfer setting value held in the column 704 is a null value, the linkage setting screen 600 in FIG. 6A is displayed.

Meanwhile, User 2 whose user ID is “2” has not permitted linkage with Resource Server A on their own account. In this case, the user's authorization for Resource Server A is not delegated to the application 110. Also, in this case, as shown in FIG. 7, information on Resource Server A is not registered for User 2. Once User 2 instructs the application 110 to display the linkage setting screen 600 for Resource Server A, the linkage setting screen 600 shown in FIG. 6B is displayed.

In a case where the User 2 presses the Link button 612 on the linkage setting screen 600 shown in FIG. 6B to link the application 110 in the new version with Resource Server A, a new row is added to the approval information management table 700 in FIG. 7, the row holding “2” in the column 701, “Resource Server A” in the column 702, approval information in the column 703, and “OFF” in the column 704. In this way, in a case where the application 110 in the new version is linked with a resource server, the column 704 of the row holding information on this resource server holds “OFF” as a default value of the sort-and-transfer setting value. For example, for “Resource Server C” on the row 712 in FIG. 7, the sort-and-transfer setting value is “OFF.” This indicates that the application 110 in the new version is linked.

In a case where the column 704 of the approval information management table 700 holds “OFF” as the sort-and-transfer setting value, the linkage setting screen 600 in FIG. 6A is displayed, as with a case where a null value is held as the sort-and-transfer setting value. Thus, in a case where the sort-and-transfer setting value held in the column 704 is either a null value or OFF, the same linkage setting screen 600 in FIG. 6A is displayed. However, different processing is performed after the radio button for “Execute” is selected in the sort-and-transfer selection region 603 in FIG. 6A. Processing can be switched because it is possible to determine whether the linkage was done in the old version or the new version by checking the sort-and-transfer setting value held in the column 704 of the approval information management table 700 in FIG. 7. Details will be described later.

### [Policy for a Service Provided by a Resource Server]

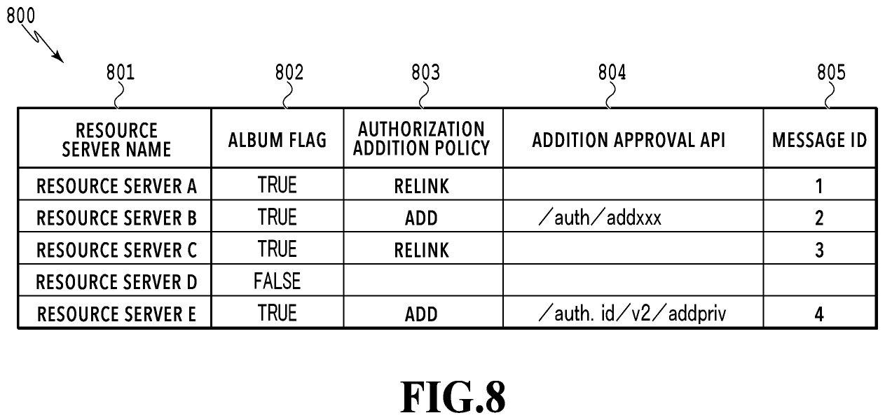

FIG. 8 is a diagram showing a policy management table 800, which is an example data structure of information managed by the resource server policy management unit 505. The resource server policy management unit 505 is described as managing policies for resource servers in a table format as an example, but the format for managing policies is not limited to a table format.

A column 801 of the policy management table 800 holds the resource server names of all the resource servers linkable with the application 110 in the image management apparatus 100.

A column 802 holds the value of an album flag indicating whether the resource server 101 whose name is held in the column 801 of the same row has the album function. The resource server 101 associated with “TRUE” as the value of the album flag has the album function. The resource server 101 associated with “FALSE” as the value of the album flag does not have the album function.

A column 803 holds content of a policy for the resource server 101 whose name is held in the column 801 of the same row, the policy being used in delegating additional authorization to the application 110. The column 803 holds “Relink,” “Add,” or a null value. “Relink” indicates that, to delegate additional authorization to the application 110, the application 110 needs to be unlinked once and then relinked. “Add” indicates that, to delegate additional authorization to the application 110, authorization can be added to the current authorization. In a case where the value of the album flag in the column 802 is “FALSE,” a null value is held in the column 803 of the same row.

A column 804 holds information on an URL to an API for adding authorization to the application 110 in a case where “Add” is held in the column 803 of the same row. Information held in the column 804 is an API published by the resource server 101. Executing this API allows the application 110 to obtain approval information again with added authorization for generating an album. In a case of the resource server 101 having “Relink” held in the column 803, the column 804 of the same row holds a null value.

A column 805 holds a message ID uniquely identifying a message to be displayed in the event where a user selects to add the sort-and-transfer function to the resource server 101 whose name is held in the column 801 of the same row.

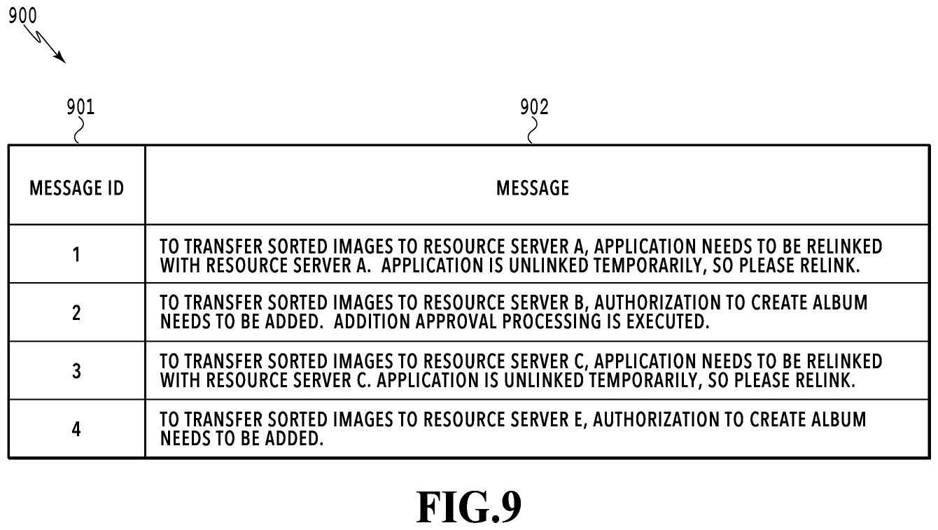

FIG. 9 is a diagram showing a message management table 900, which is an example data structure for managing messages corresponding to message IDs. A column 901 of the message management table 900 holds the aforementioned message IDs.

A column 902 holds a message identified by the message ID held in the column 901 of the same row. A message suitable for the policy for the resource server 101 is registered in advance in the column 902.

Data held in the policy management table 800 and the message management table 900 are registered in advance by a system administrator of the image management apparatus 100 according to the new function added to the application 110 in the new version. As needed, the system administrator edits the data held in the policy management table 800 and the message management table 900. For example, the system administrator edits the tables in the following cases: a new resource server 101 is added, a registered resource server 101 is deleted, and a policy for a resource server is changed.

### [Flowcharts]

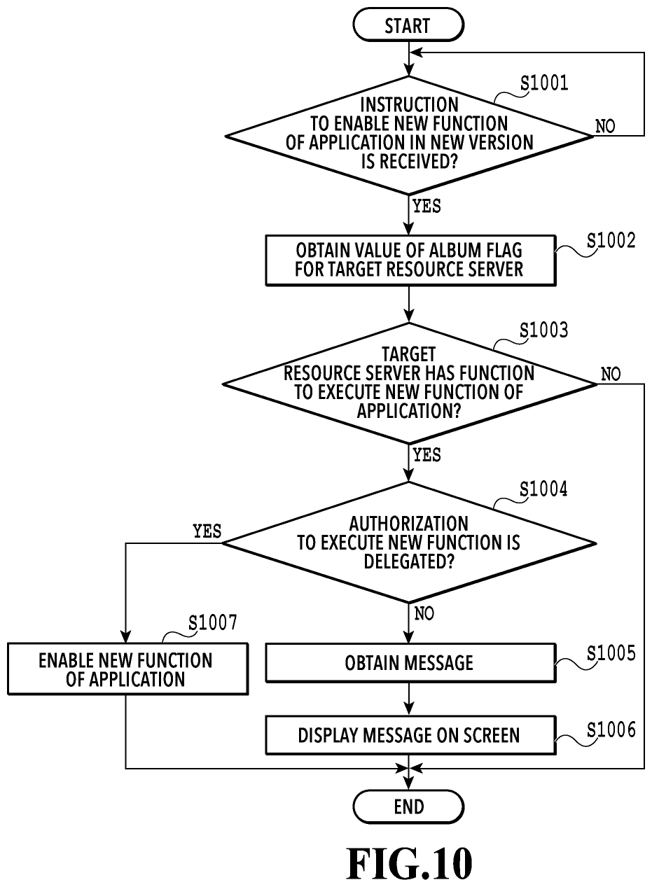

FIG. 10 is a flowchart illustrating processing for enabling sort-and-transfer. The processing in the flowchart in FIG. 10 is executed as follows: program code stored in the ROM 203, the HDD 209, or the external storage device 210 is loaded into the RAM 202 and is executed by the CPU 201. Alternatively, some or all of the functions in the steps in FIG. 10 may be implemented by hardware such as an ASIC or an electronic circuit. The letter “S” used in the description of the processing means that it is a step in the flowchart. This applies to the other flowcharts herein as well.

The flowchart in FIG. 10 is started once the linkage setting screen 600 in FIG. 6A is displayed on the user terminal 102. The flowchart in FIG. 10 is described assuming that, unless otherwise noted, the target resource server is the resource server 101a under the resource server name of Resource Server A. Also, the application 110 is an application 110 in the new version.

In a case of configuring settings related to linkage with a target resource server 101a, a user selects the target resource server on a screen presented by the application 110 and displayed on the user terminal 102. From the approval information management table 700 in FIG. 7, the application 110 extracts a row holding the user ID of the user and the name of the target resource server 101a selected by the user and obtains the sort-and-transfer setting value in the column 704 of the extracted row. In a case where the sort-and-transfer setting value is a null value or OFF, the linkage setting screen 600 shown in FIG. 6A is displayed on the user terminal 102, with the radio button for “Do not execute” being selected by default in the sort-and-transfer selection region 603.

In S1001, the linkage setting reception unit 510 determines whether the state of the sort-and-transfer selection region 603 on the linkage setting screen 600 in FIG. 6A has been changed from the state where the radio button for “Do not execute” is selected to a state where the radio button for “Execute” is selected. If the linkage setting reception unit 510 determines that the user changed the state of the sort-and-transfer selection region 603 to the state where the radio button for “Execute” is selected, the processing proceeds to S1002.

In S1002, the message determination unit 507 searches the column 801 of the policy management table 800 in FIG. 8 for a row holding the name of the target resource server 101a. The value of the album flag and a message ID are obtained from the column 802 and the column 805 of the row associated with information on the target resource server 101a found as a result of the search. In a case of Resource Server A, “TRUE” is obtained as the value of the album flag, and “1” is obtained as the message ID.

In S1003, based on the value of the album flag obtained in S1002, the message determination unit 507 determines whether the target resource server 101a has the album function. If the value of the album flag obtained is “TRUE,” the message determination unit 507 determines that the target resource server 101a has the album function (YES in S1003), and the processing proceeds to S1004. If the value of the album flag is “FALSE,” the message determination unit 507 determines that the target resource server 101a has no album function (NO in S1003), and the flowchart ends. If the target resource server 101a has no album function, as described earlier, the application 110 cannot perform sort-and-transfer with the target resource server. Thus, the application 110 cannot allow the radio button for “Execute” to be selected in the sort-and-transfer selection region 603. This is why the flowchart ends. Thus, the message determination unit 507 may perform control to display a message on the user terminal 102, indicating that it is not possible to enable sort-and-transfer with the target resource server.

In S1004, from the approval information management table 700 in FIG. 7, the authorization determination unit 504 extracts a row holding the user ID of the user and the name of the target resource server 101a and obtains approval information held in the column 703 of the extracted row.

The authorization determination unit 504 transmits the obtained approval information to the target resource server 101a and inquires about the scope of authorization delegated to the application 110. Based on the results of the inquiry, the authorization determination unit 504 determines whether authorization to generate an album is included in the scope of authorization granted to the application 110.

As described earlier, in a case where the sort-and-transfer setting value is a null value, the application 110 in the old version has already been linked with the target resource server 101a, and thus only authorization to save images is delegated to the application 110. Thus, authorization to generate an album is not delegated to the application 110. For this reason, in principle, in a case where the sort-and-transfer setting value is a null value, it is determined that authorization to generate an album is not included. If the authorization determination unit 504 determines that authorization to generate an album is not delegated to the application 110 (No in S1004), the processing proceeds to S1005.

If “NO” is held as the sort-and-transfer setting value, it means that the application 110 in the new version is linked with the target resource server 101a, but sort-and-transfer has not been enabled yet. Usually, authorization to generate an album in the target resource server 101a is delegated to the application 110 at the time of linking the application 110 in the new version. Thus, in principle, in a case where “NO” is held as the sort-and-transfer setting value, it is determined that the application 110 has authorization to generate an album. If the authorization determination unit 504 determines that the application 110 has already been granted authorization to generate an album (Yes in S1004), the processing proceeds to S1007. S1007 will be described later.

In S1005, from the message management table 900 in FIG. 9, the message determination unit 507 obtains a message corresponding to the message ID obtained in S1002.

In S1006, the message presentation unit 508 generates information used to display the message screen 1100 (see FIGS. 11A to 11C), which is a screen including the message obtained in S1005 and transmits the generated information to the user terminal 102. The user terminal 102 displays the message screen 1100. Then, the flowchart in FIG. 10 ends. Also, the linkage setting screen 600 is closed.

FIGS. 11A to 11C are diagrams each showing an example of a message screen displayed on the user terminal 102 as a result of S1006. FIG. 11A is a diagram showing an example of the message screen 1100 displayed in a case where the authorization addition policy for the target resource server 101a is “Relink.” FIG. 11B is an example of the message screen 1100 displayed in a case where the authorization addition policy held in the column 803 for the target resource server is “Add.”

A system administrator of the image management apparatus 100 prepares a message template for a case where the authorization addition policy is “Relink” and a message template for a case where the authorization addition policy is “Add.” Then, the message management table 900 in FIG. 9 holds messages generated from the templates corresponding to the authorization addition policies for the respective resource servers 101. Thus, in S1006, a message corresponding to the authorization addition policy for the target resource server is displayed. In this way, displaying a message corresponding to the policy for the target resource server makes it possible to prompt the user to perform a necessary action.

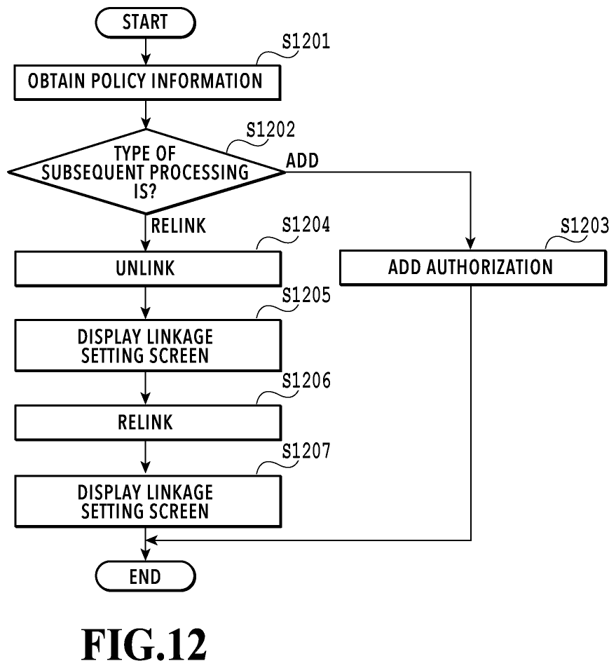

FIG. 12 is a flowchart showing an example of processing performed after the message screen 1100 is displayed on the user terminal 102.

In the present embodiment, the message screen 1100 includes an OK button 1101, and the flowchart in FIG. 12 starts upon pressing of the OK button 1101. The flowchart in FIG. 12 may start once an operation for closing the message screen 1100 is performed.

Note that the OK button 1101 does not have to be included in the message screen 1100. In this case, the flowchart in FIG. 12 may start once, for example, the message screen 1100 is displayed.

Also, as shown in FIG. 11C, the message screen 1100 may include a Cancel button 1102. Upon pressing of the Cancel button 1102, the result of the processing in the flowchart in FIG. 10 may be cancelled, bringing back the state where the radio button for “Do not execute” is selected in the sort-and-transfer selection region 603 on the linkage setting screen 600.

In S1201, the processing determination unit 511 searches the column 801 of the policy management table 800 in FIG. 8 for a row holding the name of the target resource server. An authorization addition policy is obtained from the column 803 of the row associated with information on the target resource server, which has been found as a result of the search. In a case where “Add” is held in the column 803, “addition approval API” in the column 804 is also obtained. In a case where the target resource server is the resource server 101a, which is Resource Server A, “Relink” is obtained.

In S1202, the processing determination unit 511 switches processing according to content of the authorization addition policy obtained in S1201. If the value of the authorization addition policy is “Add,” the processing proceeds to S1203.

In S1203, the addition approval unit 513 performs processing so that authorization to generate an album may be additionally approved from the target resource server. First, the addition approval unit 513 executes an API for addition approval from the target resource server obtained in S1201. As a result of the API execution, the addition approval unit 513 obtains approval information from the target resource server. In the approval information management table 700 in FIG. 7, the addition approval unit 513 updates approval information held in the row holding the user ID of the relevant user and the name of the target resource sever. Also, the sort-and-transfer setting value on the same row is changed to “ON.” Then, the flowchart in FIG. 12 ends.

For example, in a case where the user ID of the user is “3” and the name of the target resource server is “Resource Server B,” approval information held in the column 703 of a row 715 in the approval information management table 700 in FIG. 7 is updated to approval information including the authorization to generate an album. Also, the sort-and-transfer setting value held in the column 704 of the row 715 is changed to “ON.”

If the processing determination unit 511 determines that the value of the authorization addition policy is “Relink,” the processing proceeds to S1204. The following description assumes that the target resource server is the resource server 101a.

In S1204, the unlink unit 512 unlinks the application 110 from the target resource server 101a. For example, in the approval information management table 700 in FIG. 7, the unlink unit 512 deletes the row holding the user ID of the relevant user and the name of the target resource server.

For example, in a case where the user ID of the user is “1” and the name of the target resource server is “Resource Server A, the row 711 is deleted from the approval information management table 700 in FIG. 7.

The reason for the unlinking is because, for the resource server whose authorization addition policy is Relink, changing authorization delegated to the application 110 is possible only at the time of linking the application 110 with the resource server. Thus, in order to delegate authorization to generate an album to the application 110 to enable sort-and-transfer with the target resource server 101a, the application 110 needs to be unlinked from the target resource server 101a once.

In S1205, the linkage setting screen presentation unit 509 displays the linkage setting screen 600 in FIG. 6B on the user terminal 102 to prompt the user to relink the application 110 with the target resource server 101a.

Once the user presses the Link button 612 on the linkage setting screen 600 in FIG. 6B on the user terminal 102, a linkage request is transmitted from the application 110 in the new version to the target resource server 101a. Receiving the request, the target resource server 101a displays a confirmation screen 410 in FIG. 4B on the user terminal 102. As described earlier, authorization delegated at the time of linking the application 110 in the new version includes authorization to generate an album.

In S1206, once the Permit button 401 is pressed on the confirmation screen 410 in FIG. 4B, the approval information management unit 502 updates the approval information management table 700 in FIG. 7 because the target resource server 101a is once again a linked resource server. Specifically, the approval information management unit 502 adds a row to the approval information management table 700 in FIG. 7, the row holding the user ID of the relevant user and “resource server A” as the name of the target resource server 101a. Approval information including authorization to generate an album is held in the column 703 of the row thus added. Also, in the column 704 of the added row, “OFF” is held as a default value of the sort-and-transfer setting value.

In S1207, the linkage setting screen presentation unit 509 displays the linkage setting screen 600 in FIG. 6A for configuring settings on the target resource server 101a on the user terminal 102 again. Then, the flowchart in FIG. 12 ends, and the flowchart in FIG. 10 starts again.

In the flowchart in FIG. 10 performed next, it is determined in S1004 that the application 110 has authorization to generate an album (YES in S1004), and the processing proceeds to S1007.

In S1007, in the approval information management table 700 in FIG. 7, the approval information management unit 502 changes the sort-and-transfer setting value to “ON,” the sort-and-transfer setting value being held in the column 704 of the row holding the user ID of the relevant user and the name of the target resource server 101a. The linkage setting screen 600 is now in a state where, as shown in FIG. 6C, the radio button for “Execute” is selected.

In this way, in the present embodiment, at the time of authorization addition, control is performed in S1006 to present the user with a message corresponding to the policy for the target resource server. For example, in a case where the authorization addition policy for the target resource server 101a is “Relink,” the application 110 is unlinked from the target resource server 101a once. After that, the user needs to instruct the application 110 to link with the target resource server 101a through the linkage setting screen 600 in FIG. 6B. If the application 110 is unlinked from the target resource server 101a without the message screen 1100 in FIGS. 11A to 11C being displayed, the user may not understand why the application 110 has been unlinked from the target resource server 101a. Then, the user may fail to perform the next operation properly. For example, in a case where the message screen 1100 in FIGS. 11A to 11C is not displayed, after unlinking the application 110 from the target resource server 101a, the user may close the linkage setting screen 600 in FIG. 6B without pressing the Link button 612 on the screen.

In the present embodiment, the message screen 1100 like the one in FIG. 11A is displayed. Thus, after unlinking the application 110 from the target resource server 101a, the user can be informed that they need to relink the application 110 by pressing the Link button 612 on the linkage setting screen 600 in FIG. 6B. This allows the application 110 to relink with the target resource server 101a smoothly after unlinking from the target resource server 101a. Thus, the sort-and-transfer function can be properly enabled for the application 110 with the resource server 101a whose authorization addition policy is “Relink.” Then, in the event where a user uploads images to the image management apparatus 100, the images are automatically sorted, and a relevant image is transferred to an album in the resource server 101a.

Also, unless the user selects the radio button for “Execute” in the sort-and-transfer selection region 603 on the linkage setting screen 600 in FIG. 6A, the processing in the flowchart in FIG. 10 is not started. Before selecting the radio button for “Execute” for the target resource server 101a, the user can still use the regular transfer function to transfer all images.

Also, in a case where the target resource server does have the album function, control is performed not to display the message screen 1100 in FIGS. 11A to 11C or not to execute the processing in the flowchart in FIG. 12. In performing sort-and-transfer with a resource server without the album function, the application 110 performs regular transfer within the authorization delegated thereto.

As thus described, the present embodiment displays, to a user who linked the application 110 in an old version to a resource server 101, a message corresponding to the policy for the resource server 101 and thereby can prompt the user to delegate authorization to the application 110.

The technique of the present disclosure can reduce load on a user which may be incurred by a version update of the application linked with a resource server.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-115713 filed Jul. 19, 2024, which is hereby incorporated by reference wherein in its entirety.

What is claimed is:

1. An image management apparatus operated by an application, the image management apparatus comprising:
an obtainment unit configured to obtain information indicating a scope of the authorization granted before a version update of the application to the application to use a linked resource server and
a notification unit configured to give a predetermined notification to a user in a case where the scope does not include authorization necessary for the user to use a function added as a result of the version update of the application.

2. The image management apparatus according to claim 1, further comprising:
a sorting unit configured to select an image meeting a sorting condition from an image of a particular user and
a transfer unit configured to transfer the image of the particular user to the linked resource server, wherein
the added function is a function where the transfer unit transfers the image meeting the sorting condition to a corresponding album in the linked resource server, and
the authorization necessary to use the added function is authorization to generate the album in the linked resource server.

3. The image management apparatus according to claim 2, wherein
the album is a function to manage an image file collectively.

4. The image management apparatus according to claim 1, further comprising
an approval information management unit configured to manage approval information issued by a resource server in a case where the application is granted authorization with associated with a value indicative of the resource server, wherein
the obtainment unit obtains the approval information associated with the linked resource server and obtains information indicating the scope by transmitting the obtained approval information to the linked resource server.

5. The image management apparatus according to claim 4, wherein
the notification unit gives the predetermined notification to the user in a case where the approval information associated with the linked resource server is issued before the version update of the application.

6. The image management apparatus according to claim 1, further comprising
a policy management unit configured to manage a policy used for a resource server to additionally grant authorization to the application.

7. The image management apparatus according to claim 6, wherein
the policy includes relinkage and addition approval,
the relinkage additionally granting authorization to the application by unlinking the application and then relinking the application,
the addition approval additionally granting authorization to the application without unlinking the application.

8. The image management apparatus according to claim 7, wherein
in a case where the policy for the linked resource server is the relinkage, the notification unit gives notification of a message including an indication that the application is unlinked from the linked resource server.

9. The image management apparatus according to claim 8, further comprising:
an unlink unit configured to unlink the application from the linked resource server after the notification of the message and
a linking unit configured to, after the application is unlinked from the linked resource server, relink the application with the resource server from which the application has been unlinked, to grant the authorization necessary to use the added function.

10. The image management apparatus according to claim 7, further comprising
an addition approval unit configured to, in a case where the policy for the linked resource server is the addition approval, request the linked resource server to add the authorization necessary to use the added function.

11. The image management apparatus according to claim 1, wherein
the notification unit gives the predetermined notification by displaying a message on the user's terminal.

12. The image management apparatus according to claim 6, further comprising
a message management unit configured to manage messages generated to correspond to the policies for resource servers, wherein
the notification unit gives the predetermined notification by obtaining a message associated with the linked resource server from the messages managed by the message management unit and displaying the obtained message on the user's terminal.

13. The image management apparatus according to claim 1, further comprising:
a screen presentation unit configured to display a setting screen for linkage with a resource server and
a reception unit configured to receive content of an operation performed by the user on the setting screen, wherein
the notification unit gives the predetermined notification in a case where the user instructs to enable the added function through the setting screen.

14. The image management apparatus according to claim 2, wherein
the transfer unit transfers the image of the particular user to a predetermined location in the linked resource server in a case where the resource server does not have the function to generate the album or a case where the user does not configure a setting to enable the added function.

15. A method for controlling an image management apparatus operated by an application, the method comprising:
obtaining information indicating a scope of the authorization granted before a version update of the application to the application to use a linked resource server and
giving a predetermined notification to a user in a case where the scope does not include authorization necessary for the user to use a function added as a result of the version update of the application.

16. A non-transitory computer readable storage medium storing a program which causes a computer to perform a control method for controlling an image management apparatus operated by an application, the control method comprising:
obtaining information indicating a scope of the authorization granted before a version update of the application to the application to use a linked resource server and
giving a predetermined notification to a user in a case where the scope does not include authorization necessary for the user to use a function added as a result of the version update of the application.
